(19) United States
(12) Patent Application Publication
(10) Pub. No.: US 2015/0081448 A1
(43) Pub. Date: Mar. 19, 2015

(54) NON-INTRUSIVE ADVERTISEMENT MANAGEMENT

(71) Applicant: Microsoft Corporation, Redmond, WA (US)

(72) Inventors: Neal Osotio, Sammamish, WA (US); Angela Moulden, North Bend, WA (US); Luis Carrasco, Bellevue, WA (US)

(73) Assignee: Microsoft Corporation, Redmond, WA (US)

(21) Appl. No.: 14/027,714

(22) Filed: Sep. 16, 2013

(51) Int. Cl. G06Q 30/02

(52) U.S. Cl. CPC G06Q 30/0269
USPC 705/14.66

(57) ABSTRACT

Architecture that advertisements enables advertisements related to user intent to be pre-staged on a z-axis, out of view of an application content layer in the x-y axis until triggered for partial or entire presentation in the content layer. The advertisement content architecture utilizes a modular, device-specific approach based upon the z-axis of the device(s) with which the user is interacting. Advertisement content is targeted (personalized) based on the user's personal preferences gathered via personal data, search history, and personal cloud data. The advertisement content and metadata are combined in a visually interesting z-axis presentation across multiple user devices. Advertisement content is mapped to the consumer decision journey to produce the desired advertisement at the right time.

### BACKGROUND

Current advertising experiences are intrusive and distracting for a user as the user engages in the content being viewed such as reading an article, watching a movie, or playing a video game, for example. Research indicates that the initial user experience is a critical “hook” for the user to continue content engagement and for the advertiser to then be provided the capability to tell their campaign in an interesting and fluid way.

Advertisements are displayed within or next to the content—in other words, on the same two-dimensional x/y axis layer as the non-advertisement content. Moreover, advertisements are generally presented in a single dimension format (static) or the format of a short video. Advertisers do not take advantage of the full capability of the operating system and/or device capabilities available for screen rendering, and particularly for smaller devices such as tablets, phones, and gaming consoles. This results in an overall poor user experience and little engagement by the user with advertisements.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables advertisements to be pre-staged away from the same view in which non-advertising content is normally presented. The pre-staged advertisements are readied on a “z-axis” behind the non-advertising content x-y layer (also referred to as the application layer) until triggered for partial or entire presentation in the content layer. Thus, the user experience is that of no perceived advertising in the content layer until triggered to be received and displayed in the content layer. This enables advertisers to present advertisements in a more interesting and engaging way by building an advertisement experience as the user engages with advertisement content. The advertisement content architecture utilizes a modular, device-specific approach based upon the z-axis of a single device with which the user is interacting and the z-axis as extended across multiple devices with which the user is associated.

The presentation of advertisement content, as obtained from the z-axis, is performed in the application surface of an in-focus device (e.g., currently experiencing user interaction as detected by user input (e.g., touch, speech recognition, gestures, mouse, etc.) and/or device sensor (e.g., an accelerometer or gyroscope, sonic sensor, audio power, physically closest to the user using geolocation data such as triangulation, global positioning system, etc.)) of multiple devices when triggered by user and/or device actions. A last-in-time stack can be maintained where the latest (or last) used device is pushed to the top of the stack as the in-focus device. Alternatively, a physical stack can also be maintained where the physically closest device is routinely detected and maintained, and deactivated (inactive) devices are removed or noted. Advertisement content can be targeted (personalized) based on the user's personal preferences gathered via personal data (e.g., a dashboard), search history, and personal cloud data to pique the user's initial interest and curiosity. The advertisement content and metadata are combined in a visually interesting presentation in a single device and/or across multiple user devices based on the device z-axis defined for a single device and a device-ordered z-axis across the multiple active and proximate user devices. The ordering can be detected and maintained in the physical stack, for example. Advertisement content is managed to present the desired advertisement at the “right viewing time”, which includes between a change of applications, between pages of application documents, switching between pages of different applications, detecting user intent to interact with advertising content, at an edge of a document being scrolled or interacted with, etc., or more generally, at any time the user may not be viewing the content layer.

The architecture can comprise a system that includes a module component that prepares (pre-stages) advertising content (e.g., personalized to the user) for a single user device or for each of multiple devices (e.g., cell phone, tablet computer, gaming computing system, etc.) according to corresponding advertisement modules (sets of one or more advertising content). A module can be a set of personalized and/or non-personalized advertisements prepared for a single user device (e.g., formatted for suitable presentation of the single device) and specific sets of advertisements formatted for corresponding user devices (e.g., a first set formatted for suitable presentation on a smartphone, a second set formatted for suitable presentation on a tablet user device, etc.).

An advertisement placement component associates and manages an advertisement module (e.g., of the one or more modules) of advertising content (also referred to as “ads”) in the z-axis layer (e.g., a single device z-axis or a multiple device z-axis).

A presentation component presents the advertising content of the advertisement module in the content layer (e.g., based on user intent of the user to engage the personalized advertising content) as presented in a display of a single device or displays of multiple active user devices. The presentation component can present the advertising content when navigation occurs between two or more content pages (“interstitial” advertising) of an in-focus device. (Note that “in-focus” is intended to mean the use of a single active device the user is interacting with and no other active user devices, as well as user interaction with a nearest user device of multiple active devices.) The advertising content, as presented in an in-focus first device of the multiple devices, is automatically presented in a second device of the multiple devices in response to the user interacting with the second device.

The advertisement placement component automatically moves a replacement advertisement into the z-axis layer advertisement module as an existing advertisement of the z-axis layer advertisement module is moved into the content layer. The replacement advertisement can be personalized as related to the user intent and/or a user interest or a non-personalized advertisement.

The presentation component selects one of the advertising content from the advertisement module (e.g., based on the derived user intent) and advances the selected advertising content in the z-axis layer for presentation in the content layer as the user engages. The advertisement placement component learns user behavior based on the user interaction and automatically adjusts (changes the advertising content composition of) the advertisement module based on the learned user behavior.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system of the disclosed architecture.

FIG. 3 illustrates an arrangement of z-axis elements of an instance of advertising content relative to an application surface and both relative to a device.

FIG. 4 illustrates an arrangement of z-axis elements that comprise an advertisement module of multiple z-axis advertisements.

FIG. 5 illustrates a set of devices on which z-axis advertisements can be implemented.

FIG. 6 illustrates migration of advertising content among multiple devices on the z-axis based on one device powering off.

FIGS. 7A-7B illustrate device and program actions relative to z-axis advertisements.

FIGS. 8A-8C illustrate mobile device and program actions relative to z-axis advertisements.

FIG. 9 illustrates a method in accordance with the disclosed architecture.

FIG. 10 illustrates an alternative method in accordance with the disclosed architecture.

FIG. 11 illustrates a block diagram of a computing system that executes advertisements in accordance with the disclosed architecture.

### DETAILED DESCRIPTION

The disclosed architecture enables z-axis advertisements, which allow advertisers to present advertisements in a more interesting and engaging way by building an advertisement experience as the user engages with advertisement content through a modular device-specific approach based upon the z-axis of a single device and of the device z-axis of multiple devices with which the user is interacting. The advertisement takes advantage of the operating systems and devices capabilities such as touch and natural user interface (NUI) gestures to increase user interest and user engagement.

More specifically, the disclosed architecture facilitates the presentation of advertisement content pre-staged in the z-axis (out of view) on an in-focus device application surface. Advertisement content can be non-personalized (non-targeted), and/or targeted (personalized) based on the user's personal preferences gathered via personal data (e.g., a dashboard), search history, and personal cloud data to pique the user's initial interest and curiosity. Presentation of the advertisement (as obtained from the z-axis) on the in-focus device can be user and/or device initiated. The advertisement content and advertising content metadata is combined with non-advertising content in a visually interesting, presentation in a single user device and/or across multiple user devices. Advertisement content is managed to be obtained and presented at the right time and not in an ad hoc manner as in existing systems.

The z-axis advertisement architecture and the inherent device interaction capabilities (e.g., touch) as facilitated by the device operating system and other programs coordinate to create an experience in a single device and/or across all user devices in an area; however, the closest (“in-focus”) z-axis will have the dominant advertisement content/module.

Advertisement content and presentation in combination with user context increase customer satisfaction across any device screen once the advertisement has been activated. Additionally, the z-axis can change as the user initiates the experience across the different device screens (or displays).

The advertisement experience learns and changes as the user engages with an advertisement or a series of advertisements. The level of presentation moves from the z-axis (advertising content) to the more prominent x-y axis (non-advertising content layer) as the user engages and as detected user interest increases. Moreover, additional advertisements continue to be stacked behind one another or replaced on the z-axis according to changes in user intent/interest.

User interaction with a device can be gesture-enabled, whereby the user employs one or more gestures for interaction. For example, the gestures can be NUI gestures. NUI may be defined as any interface technology that enables a user to interact with a device in a “natural” manner, free from artificial constraints imposed by input devices such as mice, keyboards, remote controls, and the like. Examples of NUI methods include those methods that employ gestures, broadly defined herein to include, but not limited to, tactile and non-tactile interfaces such as speech recognition, touch recognition, facial recognition, stylus recognition, air gestures (e.g., hand poses and movements and other body/appendage motions/poses), head and eye tracking, voice and speech utterances, and machine learning related at least to vision, speech, voice, pose, and touch data, for example.

NUI technologies include, but are not limited to, touch sensitive displays, voice and speech recognition, intention and goal understanding, motion gesture detection using depth cameras (e.g., stereoscopic camera systems, infrared camera systems, color camera systems, and combinations thereof), motion gesture detection using accelerometers/gyroscopes, facial recognition, 3D displays, head, eye, and gaze tracking, immersive augmented reality and virtual reality systems, all of which provide a more natural user interface, as well as technologies for sensing brain activity using electric field sensing electrodes (e.g., electro-encephalograph (EEG)) and other neuro-biofeedback methods.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

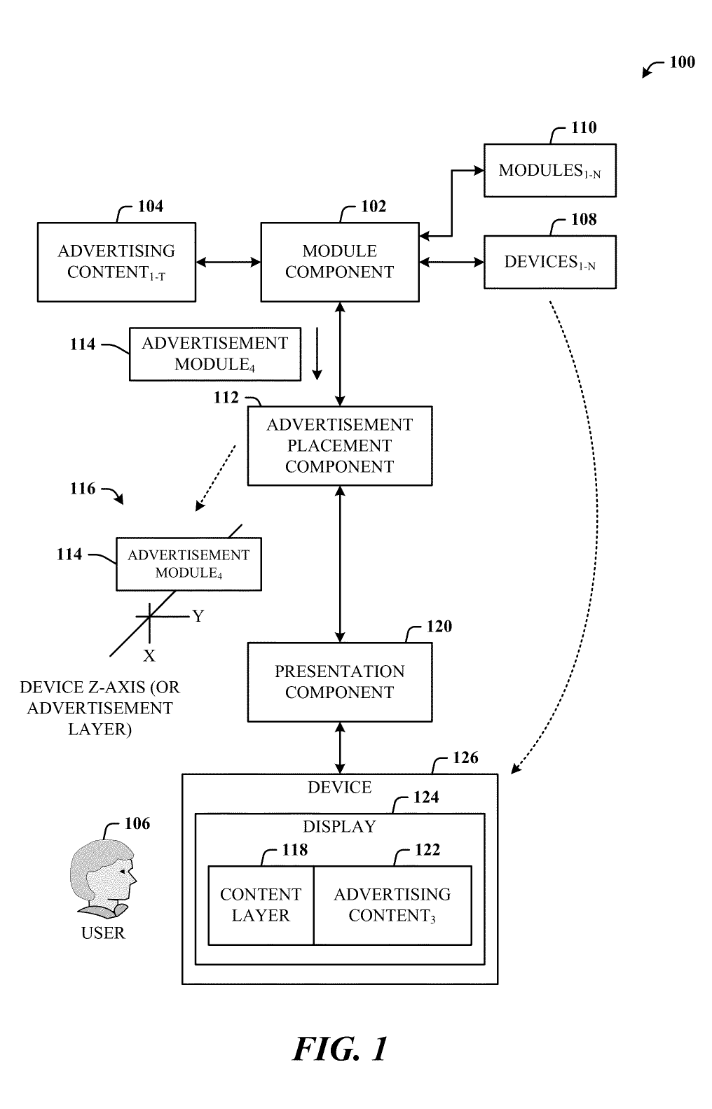

FIG. 1 illustrates a system 100 in accordance with the disclosed architecture. The system 100 can include a module component 102 that obtains personalized and/or non-personalized advertising content 104 for a single user device 126 or for multiple devices 108 (e.g., cell phone, tablet computer, gaming computing system, etc.). The advertising content 104 can be instances of media types such as an image, a video, text, etc., or combinations thereof. The advertising content 104 can be a large pool of content submitted by advertisers and from which an advertisement module 114 (of the modules 110) of content is created and assigned to a user and to a specific user device (e.g., a cell phone). A same or different advertisement module of the modules 110 may be created for a second device (e.g., a tablet) of the user devices 108, and so on. Thus, the modules 110 of advertising content define the advertising content 104 and content types, content dimensions, etc., needed for presentation on specific user devices.

An advertisement placement component 112 associates and manages the advertisement module 114 (of the modules 110) of (personalized) advertising content 104 (also referred to as “ads”) in a z-axis layer 116 (also referred to as an advertisement layer). The z-axis layer 116 is different than a content layer 118 (also referred to as an application layer or non-advertisement layer) where application content is shown and enabled for user interaction.

A presentation component 120 (e.g., a network services, user device application and/or operating system rendering program) presents the advertising content 104 (e.g., advertising content₃ 122) of the advertisement module 114 in the content layer 118, as presented in a display 124 of a device 126 (of the devices 108). The presentation of the advertising content 104 (e.g., advertising content₃ 122) of the advertisement module 114 in the content layer 118 can alternatively be based on user intent of the user 106 to engage the advertising content 122

The presentation component 120 presents the advertising content 122 when navigation occurs between content pages of an in-focus device (e.g., device 126 of the devices 108). The advertising content 122, as presented in an in-focus first device (the device 126) of the multiple devices 108, is automatically presented in a second device of the multiple devices 108 in response to the user interacting with the second device (i.e., the second device becomes the in-focus device).

The advertisement placement component 112 automatically moves a replacement advertisement into the advertisement module 114 as an existing advertisement (the advertising content 122) of the advertisement module 114 is moved into the content layer 118. The replacement advertisement can be related to the user intent and/or a user interest.

The presentation component 120 selects one of the advertising content (e.g., the personalized advertising content 122) from the advertisement module 114 and advances the selected advertising content 122 in the advertisement layer for presentation in the content layer 118 as (relative to) the user engages.

The advertisement placement component 112 learns user behavior based on the user interaction and automatically adjusts (changes the advertising content composition of) the advertisement module 114 based on the learned user behavior.

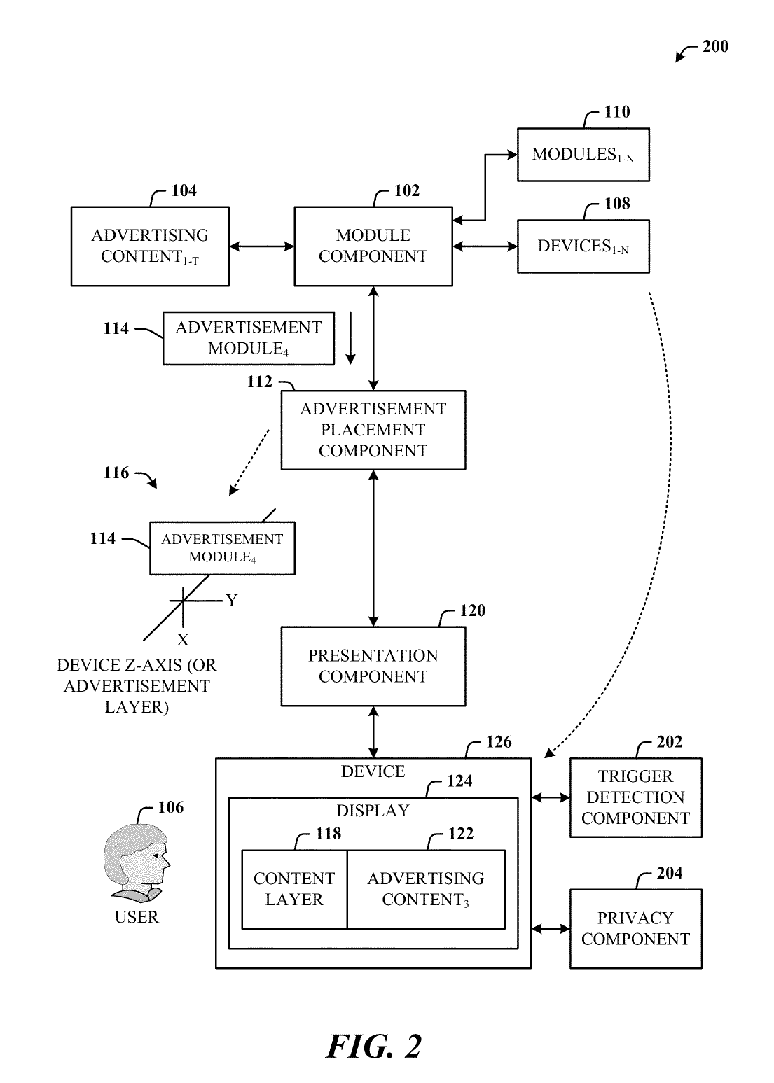

FIG. 2 illustrates an alternative system 200 of the disclosed architecture. The system 200 comprises the components and items of the system 100 of FIG. 1, in addition to a trigger detection component 202 and a privacy component 204. The trigger detection component 202 detects trigger signals such as device movement (e.g., tilting, acceleration, etc.), user interaction (e.g., touch or other gestures), content page navigation (e.g., scrolling content in any direction), and geolocation data (e.g., geographical location data such as latitude/longitude coordinates) to communicate (e.g., push or pull) personalized advertising content for presentation in the content layer 118.

The privacy component 204 enables the user to opt-in or opt-out of authorized and secure handling of user information such as tracking information and as personal information (e.g., preferences) that may have been obtained. The privacy component 204 also ensures the proper collection, storage, and access to the subscriber information while allowing for the dynamic selection and presentation of the content, features, and/or services that assist the user in obtaining the benefits of a richer user experience when using the disclosed invention.

The design of the advertisements to accommodate different devices is a differentiator from existing systems. The z-axis advertisements are created in a modular fashion and built to fit across any user device with an overarching goal to improve user satisfaction to the point of increasing the user engagement in the advertising experience.

Essentially, the advertisement(s) lies out of view (on the z-axis) and behind content of the content layer, and displays when the user moves between pages/screens. Additionally, multiple advertisements can be placed on the z-axis (in the advertisement module 114) as appropriate for the user. Properly targeted (personalized), the personalized advertisement may encourage further advertisement interaction. Once the user engages the advertisement, the advertisement becomes the focus of the screen (display) and thus, engages the advertisement content in the content layer (x-y axis).

Additionally, the advertisement automatically and simultaneously displays on all other available device screens (e.g., smartphone, gaming system, laptop, tablet, etc.) in response to user engagement. For example, active devices in the proximate area of the user will also be made ready with corresponding advertisement modules to display the same content or related variations of the content if the user selects content on the in-focus device.

Each device (screen) has a tailored advertising experience (according to the advertisement module) of content that is built and formatted for the device. As the user's device and z-axis change, by picking up a device, for example, advertisement content is automatically shown on other active devices to continue the user's experience.

Modular templates based on the vertical and stages of the consumer journey ensure the advertiser has the desired advertisement at the appropriate time. For example, each module can show content for travel, retail, etc., on a specific device. The advertising content can be targeted based on the user's personal preferences to pique the user's initial interest and curiosity.

The sale of the advertisements can be on a module basis (e.g., having a “shopping” module across the mobile phone, laptop and tablet in an automobile vertical module). Each module can be tailored for the optimum experience. The price per module can be also configured to pay on a per-screen basis (that the user interacts with) or paid by dwell time (the amount of time the user stays engaged with the advertising content), in addition to the typical click-through rate. The advertiser can create one set of assets to go across different devices, and then can be charged accordingly based on what the users interact with. Typical monetization strategies can apply as another layer. Other revenue generators include, but are not limited to, subscribing marketers contributing paid content to share within the advertisements, and the subscription company charging the marketers based on the effective cost per thousand impressions of the advertising.

With respect to the search engine and cloud backend integration, current content from a search engine can power the initial set of data for end users; however, the power of the advertisement experiences lies in learning what the user is interested in and showing the right content at the right time and right presentation level (e.g., showcasing a car in the initial z-axis layer during the research/explore phase of the buying journey and then moving to a more visible layer once the user has indicated a buy intent). These cues can evolve from the search engine search/shopping history, social data from a social network (e.g., Facebook) and any relevant information gleaned from device usage (e.g., gaming system, tablet, etc.) from history information (e.g., in the cloud) shown on the right device at the right time. The identification of time, geographical location, and pages viewed can factor into re-messaging an experience and/or creating additional experiences in the z-axis.

The disclosure finds particular implementation with devices and software that employ a “bounce-on-content-beginning and/or end” behavior. In other words, on a device, when a user scrolls to the top/bottom or left/right within the bounds of the current window, a “bounce” interaction occurs that shows a certain type of space (e.g., negative space) to indicate content boundaries. The z-axis advertisement is shown in this negative space. This behavior can occur across all user devices.

The advertisements can be created using existing technologies. An advertisement software development kit (SDK) can run on a device. The purpose of the SDK is to determine when to show the advertisement (e.g., as the user approaches an application edge—beginning and/or end), to handle tracking data to make the correct request for the correct advertisements to the server, and to handle advertisement rotation (when to show a new advertisement). For example, the advertisements can be shown when the user switches applications (the SDK runs at the OS level), and the advertisements can be shown when the application “bounces” (when the user reaches a content edge). In this latter case, the SDK runs at the application level. The content edges can be described as the visual boundaries of the content in the content layer. Thus, as the user swipes forward or backward (gestures for touch-based interfaces and non-contact (or air gesture) interfaces), for example, to navigate between webpages, each webpage boundary can be an edge: the left edge of the page, the right edge of the page, the top edge of the page, and the bottom edge of the page.

With respect to the advertisement delivery/pipeline, advertisements can be authored (created) using existing methods for advertisement creation, and booked using already existing methods (e.g., Bing Advertisements™). Booking occurs when a marketer works directly with the subscription company or via self-serve tools to enable campaign creation (dates, times, devices) and campaign assets (gaming devices, desktop devices, mobile devise, etc.). These advertisements can be of a specific kind and thus, billed accordingly. The advertisements can be delivered using an SDK, which delivers the advertisements, receives and sends tracking data to a server to obtain the appropriate advertisement at the appropriate time, manages advertisement rotation, creates the appropriate advertisement container for the advertisement to be displayed, and displays the advertisement when a trigger occurs.

Signals and triggers are used to determine when and how to display and change the advertisements. As described herein, z-axis advertisements can be shown when the user reaches the end of the content/screen or scrolls back to the beginning of the content/screen, and the screen bounces-on-content-end to indicate that it is the beginning/end of the content/page, thus revealing the z-axis advertisement(s). The screen bounce technology can occur across all devices and be utilized across touch screen, NUI, and desktop environments.

With respect to the trigger mechanisms, the z-axis advertisements architecture can utilize the screen bounce capabilities as sensed by onboard device sensors such as an accelerometer, gyroscope, or device movement when a user physically moves the device. Additionally, the z-axis advertisements can also be triggered via geolocation technologies (e.g., triangulation, global positioning system (GPS), etc.) when a user walks by, for example, a GPS-enabled retailer, thus pushing/pulling a z-axis advertisement and then vibrating (or some other sensory output) to indicate that an advertisement is present.

Put another way, the advertisement placement component 112 associates and manages the advertisement module 114 of advertising content 104 for the device 126 of the user 106. The advertising content 104 can be pre-staged in the advertisement layer (or z-axis layer) for presentation in the content layer 118. The presentation component 120 presents the advertising content 104 in the content layer 118 when navigation occurs between content pages in the content layer 118.

The presentation component 120 presents advertising content 122 when navigation occurs between content pages of an application of an in-focus device (e.g., the device 126). The advertising content 104, as presented in an in-focus first device of multiple user devices, is automatically presented in a second device of the multiple user devices in response to the user interacting with the second device. The advertisement placement component 112 automatically moves replacement advertisement content into the advertisement module 114 as existing advertisement content of the advertisement module 114 is moved into the content layer 118. The replacement advertisement content can be related to the user intent or a user interest.

The presentation component 120 selects one of the advertising content from the advertisement module 114 and advances the selected advertising content in the advertisement layer for presentation in the content layer 118 relative to user engagement of presented content. The advertisement placement component 112 learns user behavior based on the user interaction and automatically adjusts the advertisement module 114 based on the learned user behavior. The trigger detection component 202 detects at least one of device movement, user interaction, content page navigation, or geolocation data, as triggers to communicate advertising content for presentation in the content layer 118.

It is to be understood that in the disclosed architecture, certain components may be rearranged, combined, omitted, and additional components may be included. Additionally, in some embodiments, all or some of the components are present on the client, while in other embodiments some components may reside on a server or are provided by a local or remove service. For example, an entire module can be pushed to the client device as a background process for presentation as selected and triggered, rather than composed in the network and individual advertisements selected and sent to the user device as needed.

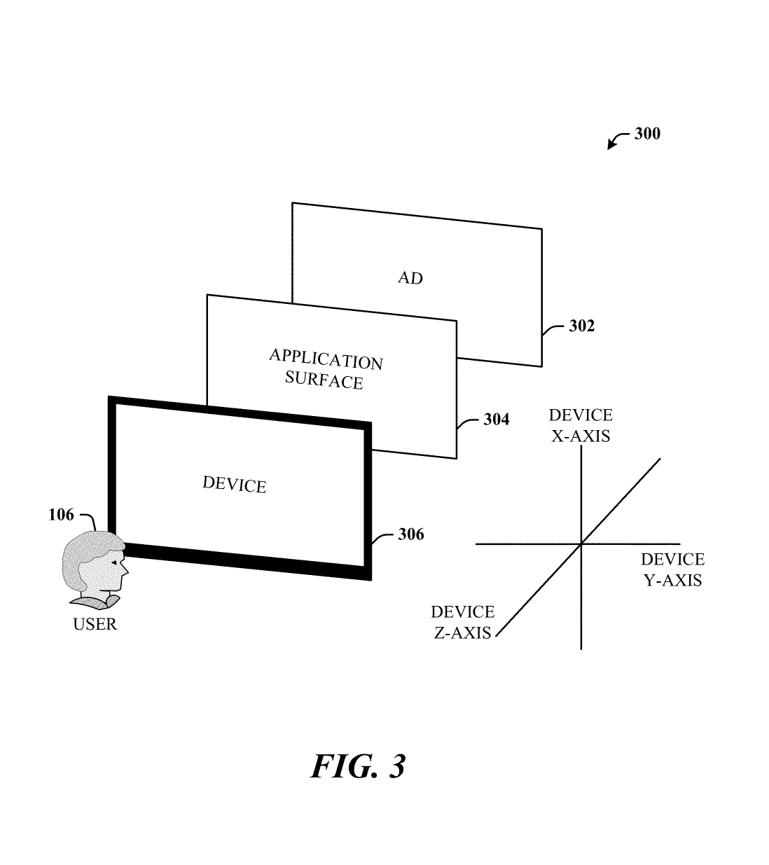

FIG. 3 illustrates an arrangement 300 of z-axis elements of an instance of advertising content 302 (referred to as an “ad”) relative to an application surface 304 and both relative to a device 306 (e.g., a tablet device). The advertising content 302 (e.g., personalized) is initially located behind the application surface 304 in the z-axis. As the user interacts with the advertising content 302 experience, this interaction evidences user intent to engage the advertisement(s). Once intent is established, the advertising content 302 moves (is moved) forward in the z-axis so that the advertising content 302 becomes the main focus of the device experience.

As depicted, the application surface 304 relates to the content layer in the x-y plane, and the advertising content 302 is behind the application surface 304 and hidden from view of the user 106 viewing the display of the device 306 until triggered to move into the application surface 304 for presentation.

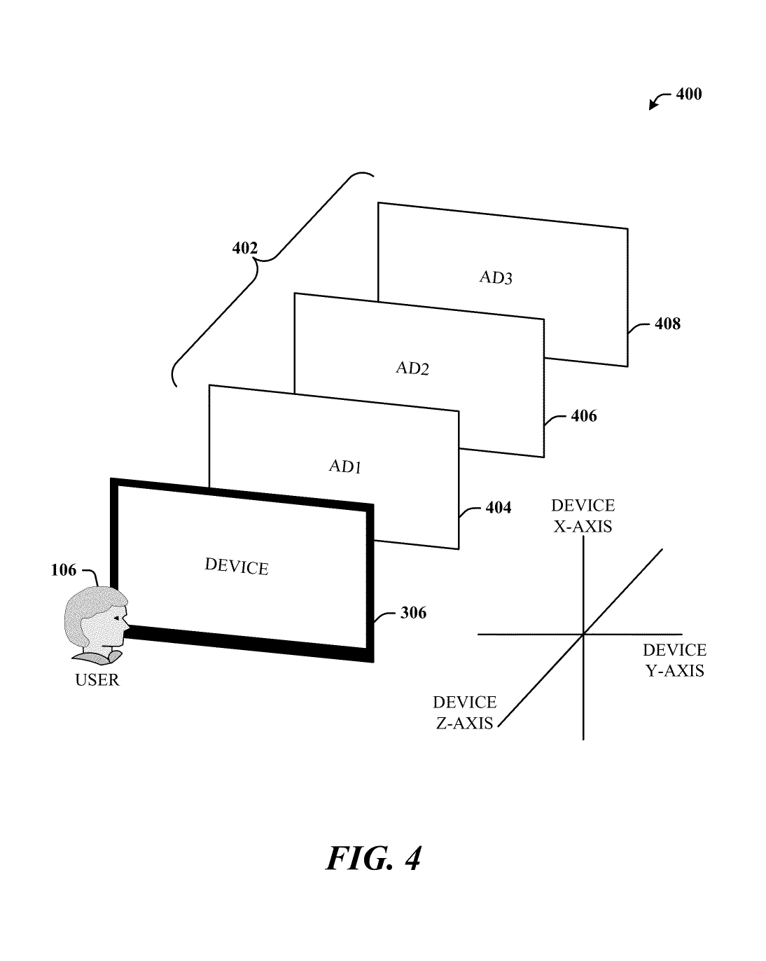

FIG. 4 illustrates an arrangement 400 of z-axis elements that comprise an advertisement module 402 of multiple z-axis advertisements appropriately targeted for the user 106. In this example, the module 402 comprises three instances of “ads”: a first advertisement (AD1) 404, a second advertisement (AD2) 406, and a third advertisement (AD3) 408. The ads (404, 406, and 408) can be related content packaged for a single user intent or combination of related or unrelated content for current user intent or anticipated user intent.

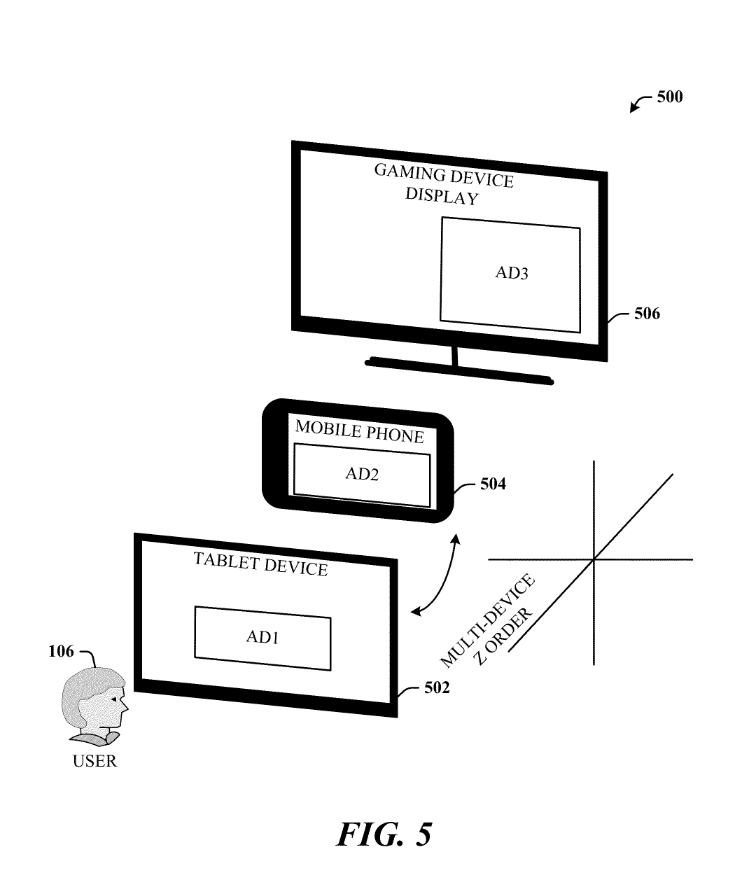

FIG. 5 illustrates a set of devices 500 on which z-axis advertisements can be implemented. Depicted are different, but related, z-axis advertisements presented on three different device screens: a tablet device 502, a mobile phone device 504, and a gaming device 506. For example, a first advertisement AD1 is presented in the application content (content layer) of the tablet device 502, a second advertisement AD2 is presented in the application content of the mobile phone device 504, and third advertisement AD3 is presented in the application content of the gaming device 506.

In one example, the advertisement can relate to a model of car, where the first advertisement AD1 in the tablet device 502 is a frontal view of the car with text that indicates “Test Drive Today”, the second advertisement AD2 is a video of the car that can be activated by the user to view, and the third advertisement AD3 is website webpage that enables the user to design-a-car according to the user's desired color and other options. Thus, the module of advertising content relates to a specific vehicle and accommodates formats for at least three different devices. As previously indicated, the module of related or unrelated advertising content can be composed for a single device as well. Here, the advertisements show different user experiences on a per-device basis. Additionally, the different advertisement can be moved among the different devices; for example, the second advertisement AD2 can be moved to the gaming device 506, while the third advertisement AD3 of the gaming device 506 can be moved to the mobile phone device 504. The tablet device 502 is the in-focus device as it is nearest the user 106.

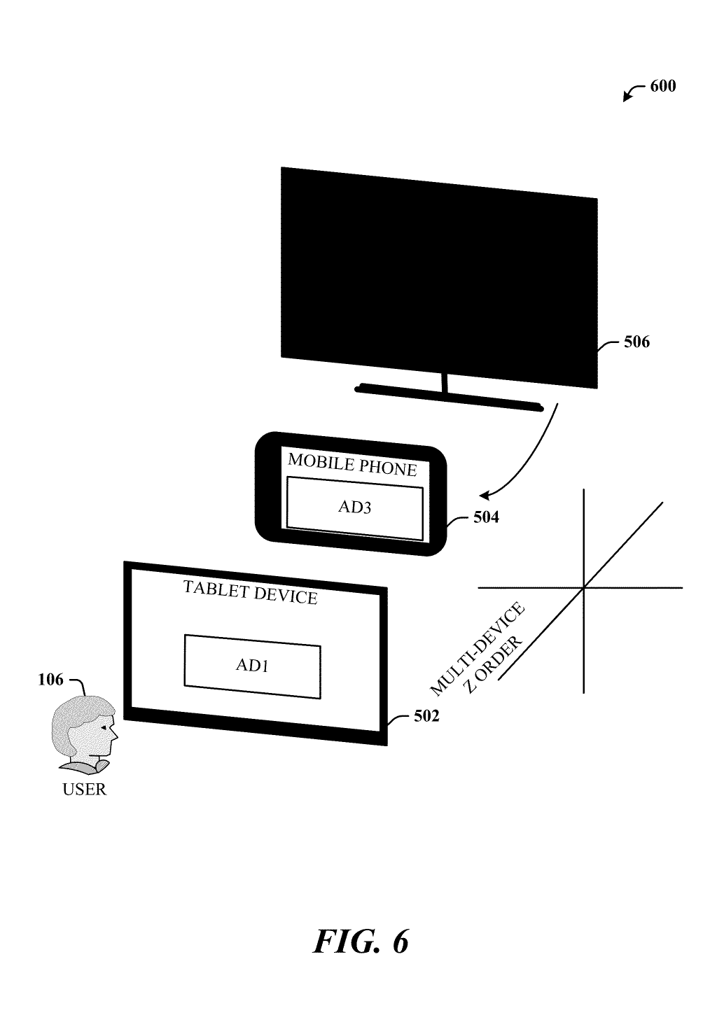

FIG. 6 illustrates migration of advertising content among the devices 500 on the z-axis based on one device powering off. As a device “falls out of” the z-axis (e.g., the device is powered off, the device disconnects from a network, etc.) the advertising module moves forward in the z-axis (in the direction of the in-focus device). In this case, the gaming device 506 powers off and the video module of the mobile phone device 504 drops out. Thus, the design-a-car module previously shown in the gaming device 506 moves forward in the z-axis (e.g., set by module preferences from the advertiser).

Following is a series of touch-based devices that enable z-axis advertising in accordance with the disclosed architecture.

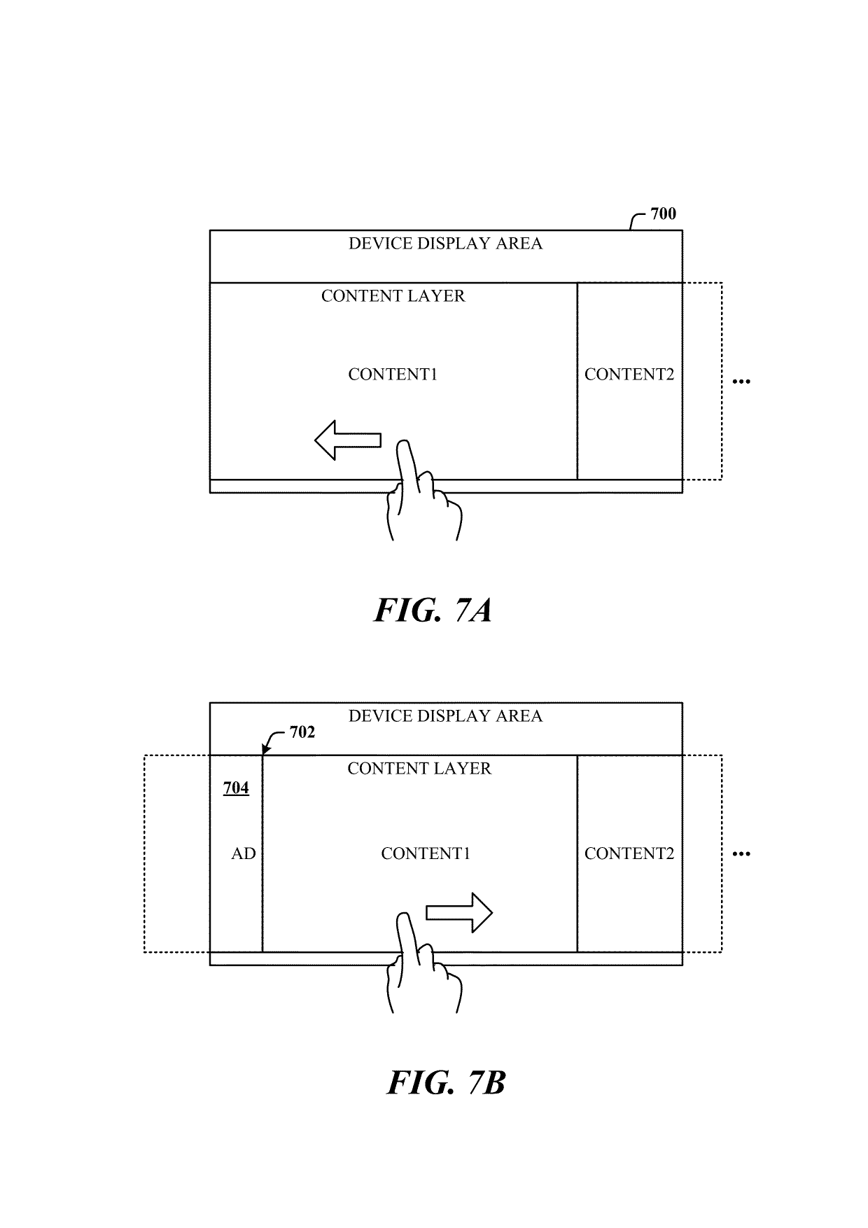

FIGS. 7A-7B illustrate device and program actions relative to user intent and z-axis advertisements. In FIG. 7A, a device display area 700 shows content (news) of the (news) application content layer. The user can use touch interaction (or other NUI gestures) to scroll content (Content1) to the left to expose additional content (Content2), and so on. The application is “clean” in that no advertisements are presented to clutter the initial user interface experience.

Continuing with the previous car example of FIGS. 5 and 6, in a previous session, the user was researching the car in a search engine, which search was stored in the user's personal cloud information. In FIG. 7B, the user touch scrolls the content1 to the right to reach the beginning 702 of the content1. When scrolling back to the beginning 702 of content1 article, at the beginning of the news application, the user is presented with a portion 704 (e.g., a “sliver”) of the car advertisement the user was previously searching, the advertisement behind (on the z-axis) the application presentation. (Note that in one application interaction, a “bump” space (small portion of UI area) is shown at the beginning and end of the application.) For devices that may not include a bump-type interface, page changes are detectable and thus, advertisements can be inserted between two pages, for example.

Using NUI touch, the user holds (pauses) the application presentation. This interaction can be interpreted by the device system as user intent/interest, and thus, the user is able to continue scrolling to show the full advertisement experience. The advertisement will initially be located on the z-axis. As the user interacts with the advertisement experience, this interaction can be processed to infer intent. Once intent is established, the advertisement moves forward in the z-axis so that the advertisement becomes the main focus of the device experience (in the x-y axis).

As the user interacts with the advertisement via touch, information is presented to the user regarding the car. As the user touch-scrolls back and forth in the presentation layer, the advertisement (in the z-axis) cycles to a different advertisement (e.g., on shoes) the user was searching in a previous session. (Note that the back-and-forth scroll interaction of viewing the advertisements presented in the z-axis can cycle through a series of advertisements specific to the user's previous searches and user mode such as browse or buy.) Again, via NUI touch, the user can holds (introduces dwell time) the application presentation, and the system understands this intent/interest and consequently, the user is able to continue scrolling to show the full advertising experience.

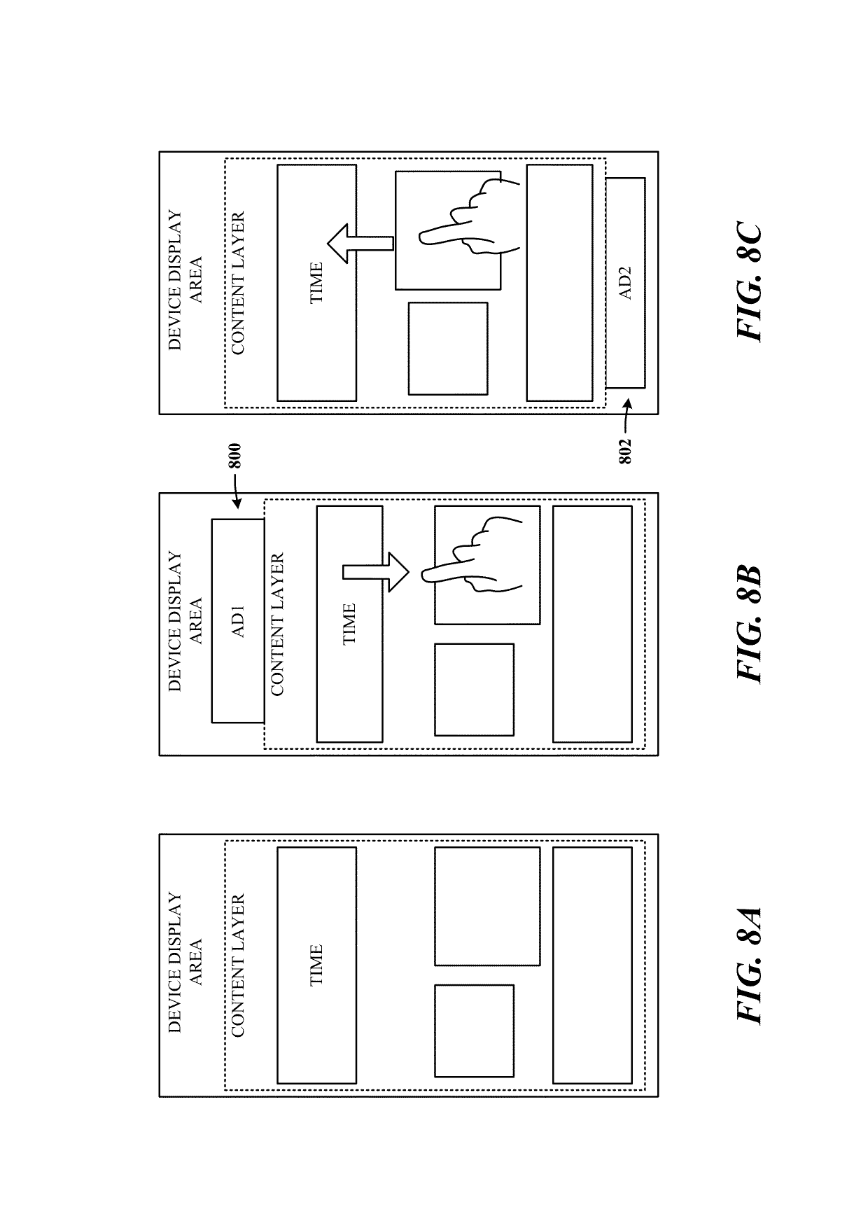

FIGS. 8A-8C illustrate mobile device and program actions relative to user intent and z-axis advertisements. FIG. 8A depicts a smartphone in a default state. FIG. 8B shows the user pulling down (touch dragging) the application interface (the content layer) to show the beginning bump space 800 and a first advertisement (AD1). FIG. 8C shows user at the end of the application interface (content layer) with bump space 802 and a second advertisement (AD2). Depending upon advertisement sequencing (pulled through intent), beginning and end bump advertisements can be different. Bump interaction is outside of the application space. Note that the bump space can be available in all other suitably-enabled devices (e.g., phone, tablet, gaming system, desktop computer, etc.) that have this inherent interaction programmed thereinto.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

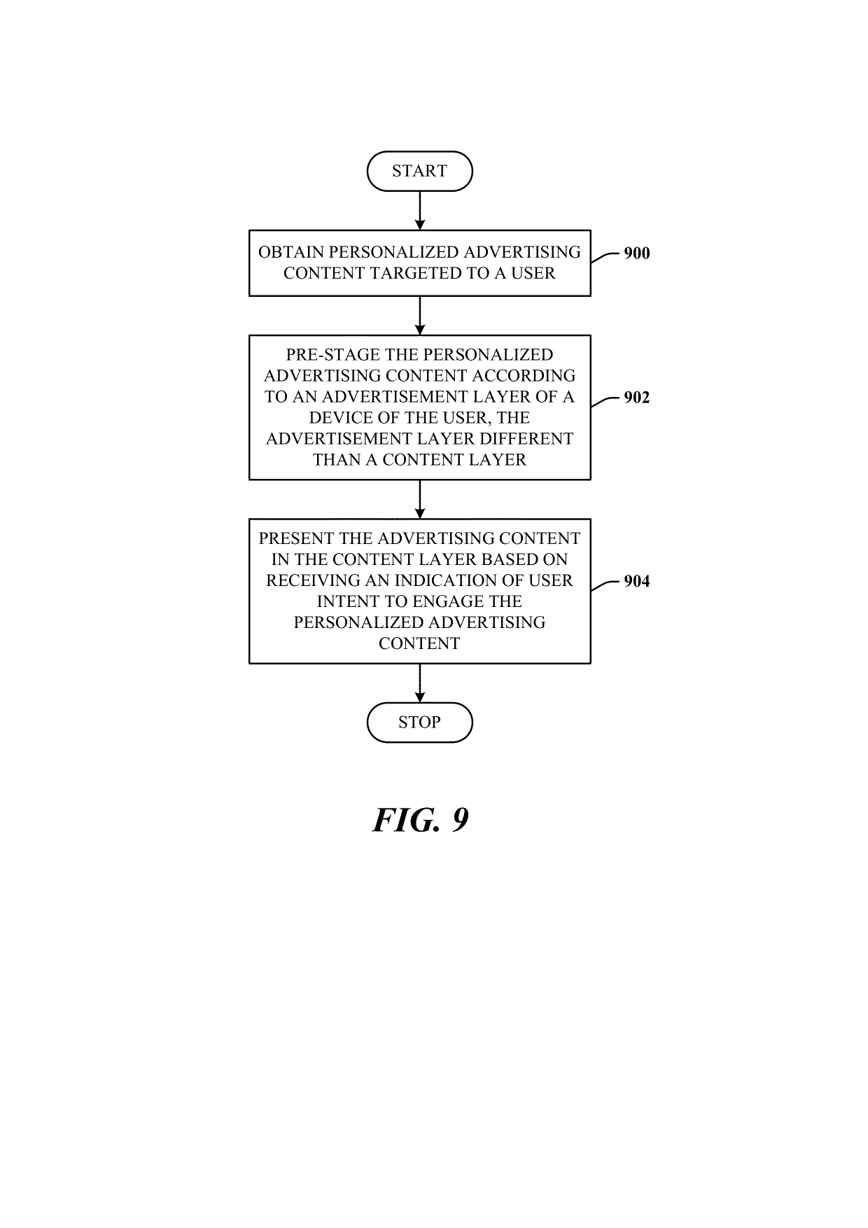

FIG. 9 illustrates a method in accordance with the disclosed architecture. At 900, personalized advertising content targeted to a user is obtained. At 902, the personalized advertising content is pre-staged according to an advertising layer of a device of the user. The advertising layer is different than a content layer. At 904, the personalized advertising content is presented in the content layer based on receiving an indication (a trigger) of user intent to engage the personalized advertising content.

The method can further comprise presenting the personalized advertising content in the content layer of an in-focus device of multiple devices in a proximity area. The method can further comprise presenting the personalized advertising content when the user navigates between pages and screens. The method can further comprise detecting the user intent based on user interactions with content in the content layer.

The method can further comprise automatically changing the personalized advertising content to present based on corresponding changes in user intent. The method can further comprise automatically changing the personalized advertising content to present based on corresponding changes in user context. The method can further comprise pre-staging the personalized advertising content according to predefined templates each of which is compatible with a corresponding device content layer. The method can further comprise automatically moving presentation of the personalized advertising content to a new device along a multi-device z-axis in response to presentation disablement of the personalized advertising content on a previous device.

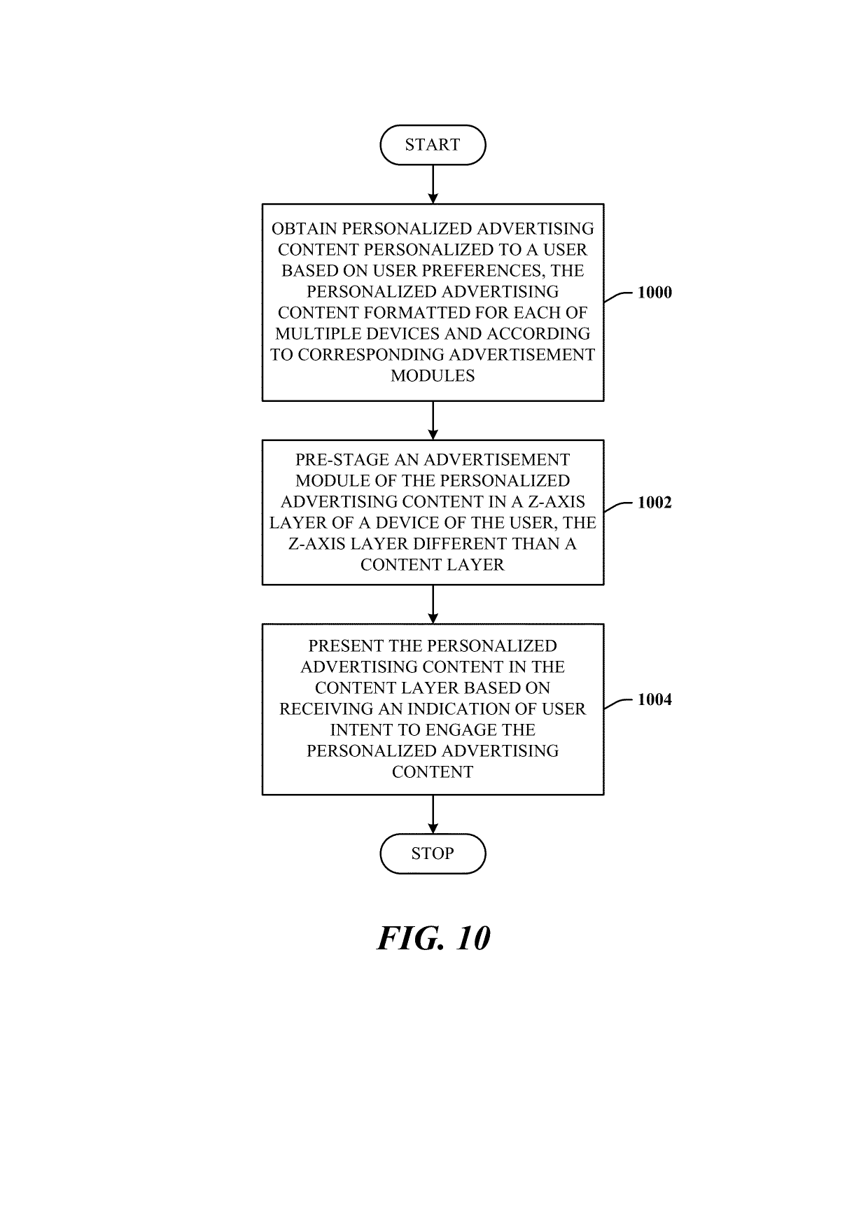

FIG. 10 illustrates an alternative method in accordance with the disclosed architecture. At 1000, personalized advertising content personalized to a user based on user preferences, is obtained. The personalized advertising content is formatted for each of multiple devices and according to corresponding advertisement modules. At 1002, an advertisement module of the personalized advertising content is pre-staged in a z-axis layer of a device of the user. The z-axis layer is different than a content layer. At 1004, the personalized advertising content is presented in the content layer based on receiving an indication of user intent to engage the personalized advertising content.

The method can further comprise detecting the user intent based on user interactions with content in the content layer and presenting the personalized advertising content when the user navigates between at least one of pages or devices. The method can further comprise automatically changing the personalized advertising content to present based on corresponding changes in user intent and user context. The method can further comprise presenting the personalized advertising content in the content layer of an in-focus device of multiple presentation devices that are in proximity to the in-focus device. The method can further comprise automatically moving presentation of the personalized advertising content to a new device along a multi-device z-axis in response to presentation disablement of the personalized advertising content on a previous device.

As used in this application, the terms “component” and “system” are intended to refer to a computer-related entity, either hardware, a combination of software and tangible hardware, software, or software in execution. For example, a component can be, but is not limited to, tangible components such as a microprocessor, chip memory, mass storage devices (e.g., optical drives, solid state drives, and/or magnetic storage media drives), and computers, and software components such as a process running on a microprocessor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

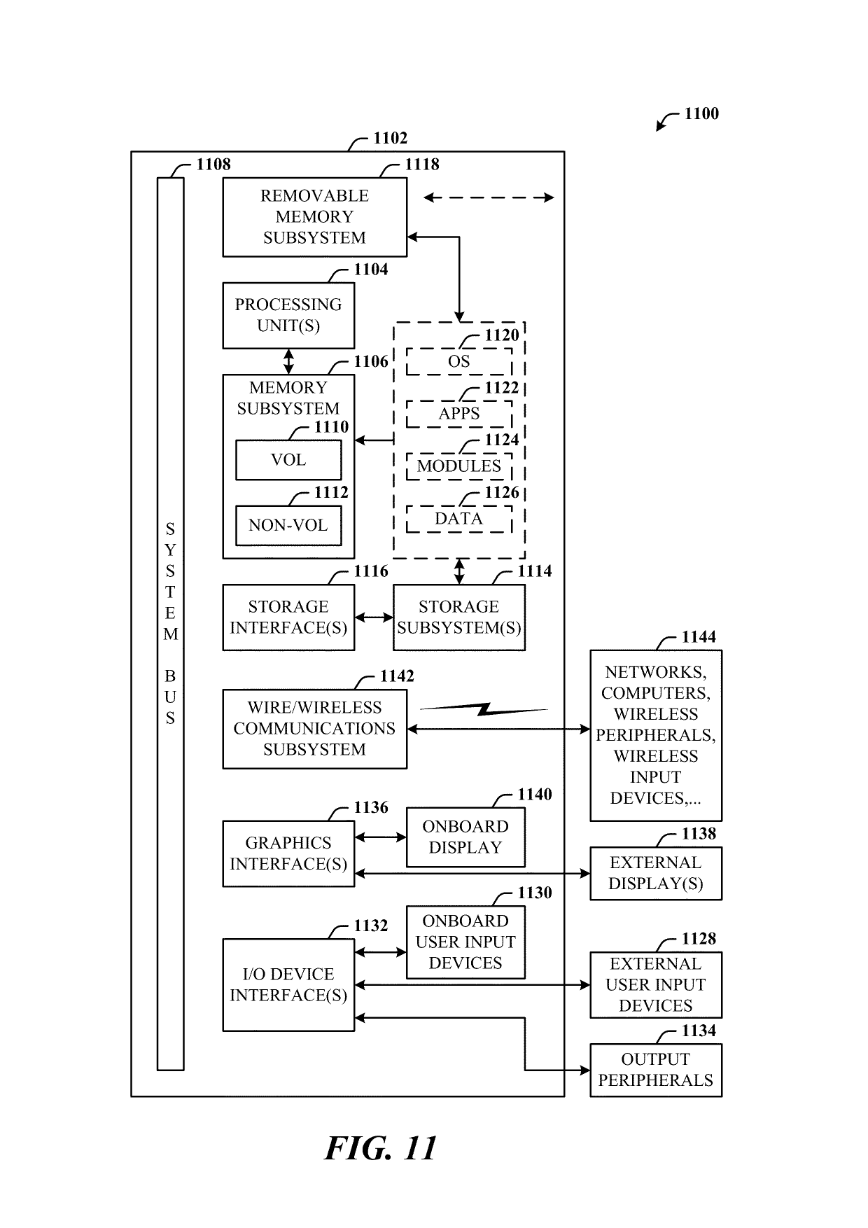

Referring now to FIG. 11, there is illustrated a block diagram of a computing system 1100 that executes z-axis intent advertisements in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having microprocessing unit(s) 1104 (also referred to as microprocessor(s) and processor(s)), a computer-readable storage medium such as a system memory 1106 (computer readable storage medium/media also include magnetic disks, optical disks, solid state drives, external memory systems, and flash memory drives), and a system bus 1108. The microprocessing unit(s) 1104 can be any of various commercially available microprocessors such as single-processor, multi-processor, single-core units and multi-core units of processing and/or storage circuits. Moreover, those skilled in the art will appreciate that the novel system and methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 1102 can be one of several computers employed in a datacenter and/or computing resources (hardware and/or software) in support of cloud computing services for portable and/or mobile computing systems such as wireless communications devices, cellular telephones, and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 1106 can include computer-readable storage (physical storage) medium such as a volatile (VOL) memory 1110 (e.g., random access memory (RAM)) and a non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the microprocessing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components and circuits. The storage subsystem(s) 1114 (physical storage media) can include one or more of a hard disk drive (HDD), a magnetic floppy disk drive (FDD), solid state drive (SSD), flash drives, and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and components of the system 200 of FIG. 2, the arrangement 300 of elements of FIG. 3, the arrangement 400 of elements of FIG. 4, be utilized by the devices 500 of FIG. 5, operate according to the migration of FIG. 6, perform according to the device and program actions of FIGS. 7A-7B, perform according to the mobile device and program actions of FIGS. 8A-8C, and the methods represented by the flowcharts of FIGS. 9 and 10, for example.

Generally, programs include routines, methods, data structures, other software components, etc., that perform particular tasks, functions, or implement particular abstract data types. All or portions of the operating system 1120, applications 1122, modules 1124, and/or data 1126 can also be cached in memory such as the volatile memory 1110 and/or non-volatile memory, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, purpose computer, or special purpose microprocessor device(s) to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 1102, and include volatile and non-volatile internal and/or external media that is removable and/or non-removable. For the computer 1102, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 1102, programs, and data using external user input devices 1128 such as a keyboard and a mouse, as well as by voice commands facilitated by speech recognition. Other external user input devices 1128 can include a microphone, an IR (infrared) remote control, a joystick, a game pad, camera recognition systems, a stylus pen, touch screen, gesture systems (e.g., eye movement, body poses such as relate to hand(s), finger(s), arm(s), head, etc.), and the like. The user can interact with the computer 1102, programs, and data using onboard user input devices 1130 such a touchpad, microphone, keyboard, etc., where the computer 1102 is a portable computer, for example.

These and other input devices are connected to the microprocessing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an advertisement placement component that associates and manages an advertisement module of advertising content for a device of a user, the advertising content pre-staged in an advertisement layer of the device for presentation in a content layer;
a presentation component that presents the advertising content in the content layer when navigation occurs between content pages in the content layer; and
at least one microprocessor that executes computer-executable instructions in a memory associated with the advertisement placement component and the presentation component.

2. The system of claim 1, wherein the presentation component presents advertising content when navigation occurs between content pages of an application of an in-focus device.

3. The system of claim 1, wherein the advertising content, as presented in an in-focus first device of multiple user devices, is automatically presented in a second device of the multiple user devices in response to the user interacting with the second device.

4. The system of claim 1, wherein the advertisement placement component automatically moves replacement advertisement content into the advertisement module as existing advertisement content of the advertisement module is moved into the content layer, the replacement advertisement content related to the user intent or a user interest.

5. The system of claim 1, wherein the presentation component selects one of the advertising content from the advertisement module and advances the selected advertising content in the advertisement layer for presentation in the content layer relative to user engagement of presented content.

6. The system of claim 1, wherein the advertisement placement component learns user behavior based on the user interaction and automatically adjusts the advertisement module based on the learned user behavior.

7. The system of claim 1, further comprising a trigger detection component that detects at least one of device movement, user interaction, content page navigation, or geolocation data, as triggers to communicate advertising content for presentation in the content layer.

8. A method, comprising acts of:
obtaining personalized advertising content targeted to a user;
pre-staging the personalized advertising content according to an advertising layer, the advertising layer different than a content layer; and
presenting the personalized advertising content in the content layer based on receiving an indication of user intent to engage the personalized advertising content.

9. The method of claim 8, further comprising presenting the personalized advertising content in the content layer of an in-focus device of multiple devices in a proximity area.

10. The method of claim 8, further comprising presenting the personalized advertising content when the user navigates between pages and screens.

11. The method of claim 8, further comprising detecting the user intent based on user interactions with content in the content layer.

12. The method of claim 8, further comprising automatically changing the personalized advertising content to present based on corresponding changes in user intent.

13. The method of claim 8, further comprising automatically changing the personalized advertising content to present based on corresponding changes in user context.

14. The method of claim 8, further comprising pre-staging the personalized advertising content according to predefined templates each of which is compatible with a corresponding device content layer.

15. The method of claim 8, further comprising automatically moving presentation of the personalized advertising content to a new device along a multi-device z-axis in response to presentation disablement of the personalized advertising content on a previous device.

16. A computer-readable storage medium comprising computer-executable instructions that when executed by a processor, cause the processor to perform acts of:
obtaining personalized advertising content personalized to a user based on user preferences, the personalized advertising content formatted for each of multiple devices and according to corresponding advertisement modules;
pre-staging an advertisement module of the personalized advertising content in a z-axis layer of a device of the user, the z-axis layer different than a content layer; and
presenting the personalized advertising content in the content layer based on receiving an indication of user intent to engage the personalized advertising content.

17. The computer-readable storage medium of claim 16, further comprising detecting the user intent based on user interactions with content in the content layer and presenting the personalized advertising content when the user navigates between at least one of pages or devices.

18. The computer-readable storage medium claim 16, further comprising automatically changing the personalized advertising content to present based on corresponding changes in user intent and user context.

19. The computer-readable storage medium claim 16, further comprising presenting the personalized advertising content in the content layer of an in-focus device of multiple presentation devices that are in proximity to the in-focus device.

20. The computer-readable storage medium claim 16, further comprising automatically moving presentation of the personalized advertising content to a new device along a multi-device z-axis in response to presentation disablement of the personalized advertising content on a previous device.
